(19) United States
(12) Patent Application Publication
(10) Pub. No.: US 2022/0080542 A1
(43) Pub. Date: Mar. 17, 2022

(54) LASER MACHINING EQUIPMENT FOR GRINDING SEMICONDUCTOR WAFERS

(71) Applicants: Beihang University, Beijing (CN); Tsinghua University, Beijing (CN)

(72) Inventors: Yingchun GUAN, Beijing (CN); Zhen ZHANG, Beijing (CN); Huaming WANG, Beijing (CN); Xinxin LI, Beijing (CN)

(21) Appl. No.: 17/382,131

(22) Filed: Jul. 21, 2021

(30) Foreign Application Priority Data
Sep. 12, 2020 (CN) . 202010955912.X

(51) Int. Cl. B23Q 1/58; B23K 26/362

(52) U.S. Cl. CPC B23Q 1/58; B23K 26/362

(57) ABSTRACT

The present disclosure relates to laser machining equipment for grinding semiconductor wafers, and belongs to the field of laser machining equipment. The laser machining equipment mainly comprises a special fixture, laser measuring meters, a laser emission module, an X-axis movement system, a Y-axis movement system, a Z-axis movement system, a liftable laser machining workbench, data transmission cables, an industrial personal computer and a human-computer interface. Compared with conventional wafer grinding equipment, short-pulse lasers are used as wafer grinding tool, and the problems of thermal influence and environmental pollution caused by chemical mechanical grinding method can be solved; laser machining is non-contact machining, so that the problem of wafer breakage caused by mechanical force can be avoided; and a wafer geometric parameter automatic detection system is adopted, automatic measurement of geometric parameters and automatic judgment of machining allowance can be achieved, and the wafer grinding quality can be accurately controlled.

### CROSS REFERENCE TO RELATED APPLICATION(S)

This patent application claims the benefit and priority of Chinese Patent Application No. 202010955912.x, filed on Sep. 12, 2020, the contents of which is incorporated by reference herein in its entirety as part of the present application.

### TECHNICAL FIELD

The present disclosure belongs to the field of laser machining equipment, and specifically relates to laser machining equipment for grinding semiconductor wafers.

### BACKGROUND

Wafer is a carrier for producing an integrated circuit, and is manufactured by cutting a silicon crystal bar into sections, grinding the outer diameters of the sections, and performing slicing, grinding, polishing and the like. Along with the continuous development of an integrated circuit manufacturing technology, the market scale of the global semiconductor industry is continuously increased, the number of required wafers is continuously increased, the diameters of the wafers are also continuously increased, and meanwhile, the requirements on the grinding and polishing quality of the wafers are also heightened.

Chemical mechanical grinding is a main method of wafer grinding, e.g., “Wafer Polishing Method” in CN201810025172.1 and “Wafer grinding method and grinding system thereof” in CN201811623632.8. According to the method, the chemical and mechanical synergistic effect is utilized, the surface of the wafer is corroded by chemical grinding liquid to generate a soft layer, the soft layer is removed by a mechanical grinding polishing head to expose the surface of a new wafer, and the steps are repeated until geometric parameters of the wafer reach standard values. However, the chemical mechanical grinding method is influenced by various factors such as applied load, the motion form of a grinding disc, the service life of a grinding pad, the viscosity of a polishing solution and the PH value of the polishing solution, and the factors influence each other, so that the chemical mechanical wafer grinding quality is difficult to regulate and control. Meanwhile, friction heat is generated under the mechanical action, the surface temperature of the wafer is increased, and heat influence is generated; and the chemical reaction on the surface of the wafer can be influenced by the rise of the grinding temperature, so that the corrosion layer depth of the wafer is difficult to control. In the wafer grinding machining process, the environment can be polluted due to the use of the chemical grinding liquid.

Therefore, it would be helpful to have an environmentally-friendly wafer grinding machining system which is high in wafer yield, high in grinding precision and capable of grinding large-diameter wafers.

### SUMMARY

In some embodiments, laser is used for replacing the chemical mechanical method to polish wafers as follows.

Firstly, the laser machining equipment for grinding semiconductor wafers comprises a special fixture (2) capable of adapting to the wafers with different diameters, laser measuring meters (3), a laser emission module (4), an X-axis movement system (5), a Y-axis movement system (7), a Z-axis movement system (6), a liftable laser machining workbench (8), data transmission cables, an industrial personal computer and a human-computer interface.

Secondly, further, the special fixture capable of adapting to the wafers with different diameters comprises a wafer supporting table (21) and an alternating-current servo motor (22) for controlling the wafer supporting table to move, the servo motor is used for precisely controlling the supporting table to move on a guide rail, the carrying function of the wafers with different diameters is achieved, and a movable guide rail of the wafer supporting table (21) is mounted on a wafer supporting table mounting platform (52).

Thirdly, the laser measuring meters (3) are laser coaxial displacement meters in a color confocal mode, geometric parameters such as wafer thickness, total thickness deviation, warping degree, bending degree and flatness can be measured, the total number of the laser measuring meters (3) is six, the laser measuring meters (3) are symmetrically arranged with the plane where the X-axis movement system is located as a symmetrical plane, and three laser measuring meters (3) are vertically arranged side by side.

Fourthly, the X-axis movement system (5), the Z-axis movement system (6) and the Y-axis movement system (7) respectively comprise an alternating-current servo motor (51) for controlling the special fixture to move, a wafer supporting table mounting platform (52), an alternating-current servo motor (61) for controlling the Z-axis to move, a laser emission device mounting platform (62), an alternating-current servo motor (71) for controlling the Y-axis to move and a Z-axis movement system mounting platform (72); and the movement of the X-axis movement system (5), the movement of the Z-axis movement system (6) and the movement of the Y-axis movement system (7) are controlled by the four alternating-current servo motors respectively.

Fifthly, further, the liftable laser machining workbench (8) comprises a laser machining platform (81) and hydraulic cylinders (82) for controlling the laser machining platform to ascend and descend; and the mounting position of the liftable laser machining workbench (8) is located below the laser emission device. The workbench can be lifted to a designated position, and the movement of the workbench is controlled by the two hydraulic cylinders (82).

Sixthly, further, the laser emission module (4) is mainly composed of a laser emission source and a high-speed scanning galvanometer, and the module is mounted on the Z-axis (6).

Seventhly, the laser emission source can be a femtosecond pulse laser, a picosecond pulse laser or a nanosecond pulse laser.

Eighthly, further, the high-speed scanning galvanometer can be a two-dimensional high-speed scanning galvanometer or a three-dimensional high-speed scanning galvanometer.

The laser machining equipment for grinding semiconductor wafers has the following advantages:

Firstly, the machining size is large. The special fixture used by the machining system can adapt to the wafers with different diameters by adjusting the fixture, and the wafers with various diameters can be machined.

Secondly, the equipment is free of heat influence. The ultrafast laser single-pulse peak power is high, machined materials are gasified in an extremely short time, almost no heat is deposited, the machining heat-affected zone can be obviously reduced, and the influence of heat effect on the wafer grinding quality is avoided.

Thirdly, the parameters are easy to adjust. Laser machining is adopted, laser machining parameters can be adjusted according to wafer machining allowance, and the wafer machining size is easy to control.

Fourthly, the machining precision is high. According to the system, the high-precision laser measuring instrument is adopted, the geometric parameters of the wafers can be measured repeatedly in the grinding process, and the grinding size precision of the wafers is guaranteed.

Fifthly, the manufacturing is green. Laser is used for replacing a traditional chemical grinding agent, and the environmental pollution is reduced.

Sixthly, the reliability is high. Non-contact laser machining can avoid wafer breakage caused by mechanical force, so that the yield of the wafers is improved.

### BRIEF DESCRIPTION OF THE DRAWINGS

FIG. 1 is an integral structural schematic diagram of the present disclosure;

FIG. 2 is a schematic diagram illustrating a special fixture in the present disclosure;

FIG. 3 is a schematic diagram illustrating an X-axis coordinated operation system;

FIG. 4 is a schematic diagram illustrating a Y-axis and Z-axis linkage movement system; and

FIG. 5 is a schematic diagram illustrating a laser machining workbench.

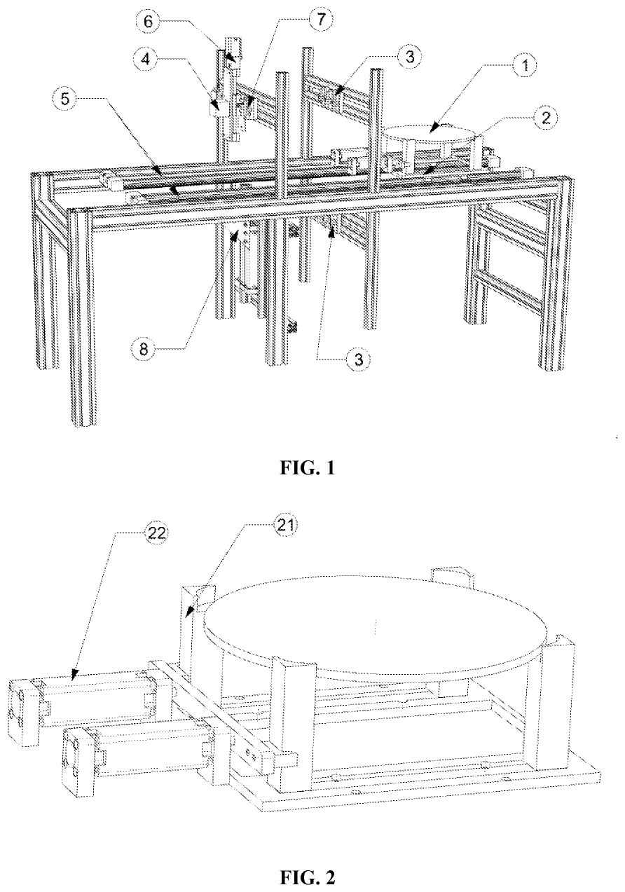

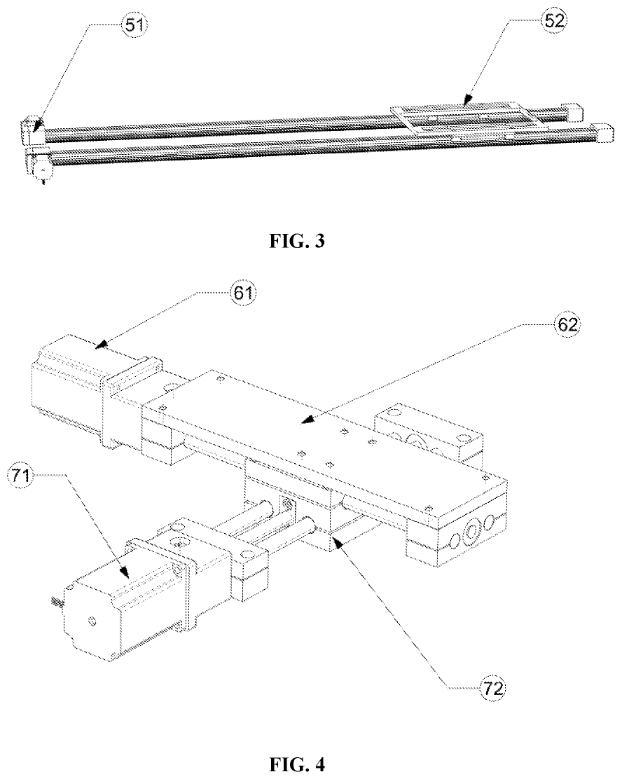

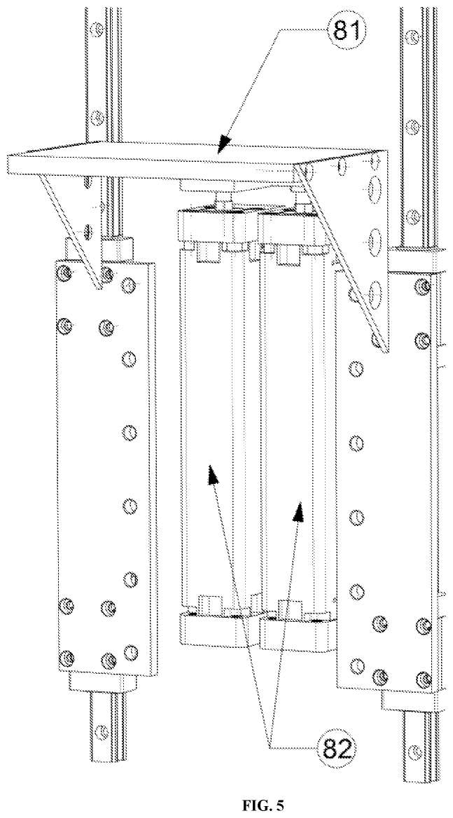

### REFERENCE SIGNS

1, wafer; 2, special fixture capable of adapting to wafers with different diameters; 21, wafer supporting table; 22, alternating-current servo motor for controlling wafer supporting table to move; 3, laser measuring meter; 4, laser emission module; 5, X-axis movement system; 51, alternating-current servo motor for controlling special fixture to move; 52, wafer supporting table mounting platform; 6, Z-axis movement system; 61, alternating-current servo motor for controlling Z-axis to move; 62, laser emission device mounting platform; 7, Y-axis movement system; 71, alternating-current servo motor for controlling Y-axis to move; 72, Z-axis movement system mounting platform; 8, liftable laser machining workbench; 81, laser machining platform; and 82, hydraulic cylinders for controlling laser machining platform to ascend and descend.

### DETAILED DESCRIPTION OF THE EMBODIMENTS

The technical scheme of the present disclosure is introduced in detail in combination with the following attached figures and specific embodiments. The examples are but not intended to limit the scope of the present disclosure.

In some embodiments, taking a wafer with the diameter of 12 inches as an example, the working process of the laser machining system is as follows:

The wafer (1) with the diameter of 12 inches is taken and placed on a wafer supporting table (21), an alternating-current servo motor (51) is started to drive an X-axis wafer supporting table mounting platform (52) to move, when the wafer moves and passes through laser measuring meters (3), the measuring meters measure geometric parameters of the wafer, and the measured geometric parameters are transmitted to an industrial personal computer through data transmission cables or other network communication mechanisms, and compared with target geometric parameter data of the wafer, and the wafer machining allowance is calculated and determined. The wafer supporting table mounting platform (52) is moved to the position over a liftable laser machining platform (8), the hydraulic cylinders (82) are started, and the machining platform (81) is lifted to a designated height. An alternating-current servo motor (71) is started to drive a Z-axis movement system mounting platform (72) to move, and a laser emission device (4) is moved to the position over the wafer; and an alternating-current servo motor (61) is started to drive a mounting platform (62) of the laser emission device (4) to move, and the distance between the laser emission device (4) and the surface of the wafer is set to a laser focal length. A laser light source is started on the human-computer interaction interface, laser machining technological parameters and a laser scanning path are set, and wafer grinding machining is carried out.

After the set laser machining time is completed, the hydraulic cylinders (82) are started, and the machining platform (81) is lowered to an initial position. The alternating-current servo motor (51) is started to drive the X-axis wafer supporting table mounting platform (52) to move, the wafer is moved to pass through the laser measuring meters (3), the geometric parameters of the wafer are measured again, the measured geometric parameter data are transmitted to the industrial personal computer, and compared with target geometric parameter data of the wafer, and the second-time machining allowance of the wafer is calculated and determined. The wafer supporting table mounting platform (52) is moved to the position over the liftable laser machining platform (8), the hydraulic cylinders (82) are started, and the machining platform (81) is lifted to the designated height. The alternating-current servo motor (61) is started to drive the mounting platform (62) of the laser emission device (4) to move, thus ensuring that the distance between the laser emission device (4) and the surface of the wafer is still the laser focal length. The laser light source is started on the human-computer interaction interface, laser machining technological parameters and the laser scanning path are set, and wafer grinding machining is carried out. The steps are repeated until the geometric parameters of the wafer meet the requirements of the target geometric parameters, the alternating-current servo motor (51) is started to drive the X-axis wafer supporting table mounting platform (52) to move, and the wafer is moved to the next process. The machining of the working procedure is completed.

In some embodiments, taking a wafer with the diameter of 8 inches as an example, the working process of the laser machining system is as follows:

The alternating-current servo motor (22) is started to drive the wafer supporting table (21) to move, so that the wafer (1) with the diameter of 8 inches can be placed on the supporting table. The steps in the firstly step are repeated, and grinding machining of the wafer with the diameter of 8 inches is completed.

The above embodiments of the present disclosure are intended to be illustrative and are not intended to limit the scope of the present disclosure, it is intended that any modification or improvement in the method, steps or conditions of the present disclosure also be considered in the scope of the present disclosure within the sprit and principle of the present disclosure.

What is claimed is:

1. Laser machining equipment for grinding semiconductor wafers, comprising a special fixture (2) capable of adapting to the wafers with different diameters, laser measuring meters (3), a laser emission module (4), an X-axis movement system (5), a Y-axis movement system (7), a Z-axis movement system (6), a liftable laser machining workbench (8), data transmission cables, an industrial personal computer and a human-computer interface.

2. The laser machining equipment for grinding semiconductor wafers according to claim 1, wherein the special fixture capable of adapting to the wafers with different diameters comprises a wafer supporting table (21) and an alternating-current servo motor (22) for controlling the wafer supporting table to move, the servo motor is used for precisely controlling the supporting table to move on a guide rail, the carrying function of the wafers with different diameters is achieved, and a movable guide rail of the wafer supporting table (21) is mounted on a wafer supporting table mounting platform (52).

3. The laser machining equipment for grinding semiconductor wafers according to claim 1, wherein the laser measuring meters (3) are laser coaxial displacement meters in a color confocal mode, geometric parameters such as wafer thickness, total thickness deviation, warping degree, bending degree and flatness can be measured, the total number of the laser measuring meters (3) is six, the laser measuring meters (3) are symmetrically arranged with the plane where the X-axis movement system is located as a symmetrical plane, and three laser measuring meters (3) are vertically arranged side by side.

4. The laser machining equipment for grinding semiconductor wafers according to claim 1, wherein the X-axis movement system (5), the Z-axis movement system (6) and the Y-axis movement system (7) respectively comprise an alternating-current servo motor (51) for controlling the special fixture to move, a wafer supporting table mounting platform (52), an alternating-current servo motor (61) for controlling the Z-axis to move, a laser emission device mounting platform (62), an alternating-current servo motor (71) for controlling the Y-axis to move and a Z-axis movement system mounting platform (72); and the movement of the X-axis movement system (5), the movement of the Z-axis movement system (6) and the movement of the Y-axis movement system (7) are controlled by the four alternating-current servo motors respectively.

5. The laser machining equipment for grinding semiconductor wafers according to claim 1, wherein the liftable laser machining workbench (8) comprises a laser machining platform (81) and hydraulic cylinders (82) for controlling the laser machining platform to ascend and descend; and the mounting position of the liftable laser machining workbench (8) is located below the laser emission device; and the workbench can be lifted to a designated position, and the movement of the workbench is controlled by the two hydraulic cylinders (82).

6. The laser machining equipment for grinding semiconductor wafers according to claim 1, wherein the laser emission module (4) is mainly composed of a laser emission source and a high-speed scanning galvanometer, and the module is mounted on the Z-axis (6).

7. The laser machining equipment for grinding semiconductor wafers according to 6, wherein the laser emission source can be a femtosecond pulse laser, a picosecond pulse laser or a nanosecond pulse laser.

8. The laser machining equipment for grinding semiconductor wafers according to claim 6, wherein the high-speed scanning galvanometer can be a two-dimensional high-speed scanning galvanometer or a three-dimensional high-speed scanning galvanometer.
